(19) United States
(12) Patent Application Publication
(10) Pub. No.: US 2014/0173413 A1
(43) Pub. Date: Jun. 19, 2014

(54) METHOD AND SYSTEM TO BUILD A REPRESENTATIVE MODEL FOR WEB PAGES TO INTERACT WITH USERS

(71) Applicant: Andres Godoy, East Palo Alto, CA (US)

(72) Inventor: Andres Godoy, East Palo Alto, CA (US)

(21) Appl. No.: 13/717,782

(22) Filed: Dec. 18, 2012

(51) Int. Cl. G06F 17/22

(52) U.S. Cl. CPC G06F 17/2247
USPC 715/234

(57) ABSTRACT

The present invention refers to a method and system to convert a web page into a representative and functional model to interact with the user, i.e., preserving all features and attributes a web page interaction provides. Such interaction occurs through a unit that accesses all user-requested contents or data. The method includes web page display and interaction in a model created for GUI devices such as desktop computers, portable and touch-screen devices, among others.

### FIELD OF THE INVENTION

The present invention relates to a method and system to build a representative model for web pages to interact with users. This representative model contains all features and functionalities of the original web page and provides the advantage of facilitating navigation in different equipment, such as touchscreen devices, through an enhanced interface for web page viewing and representative display of all contents thereof.

### BACKGROUND OF THE INVENTION

One of the problems caused by increased internet use is that, as connectivity levels rise thanks to improved bandwidth, web pages can include more information. These pages, considering increased numbers of Internet users and their requirements, must be more interactive and easy to use. In this context, access rates to this information over the net by portable devices is currently rising and data has not been adapted for easy access through this equipment. On the other hand, users do not wish to use menus, scroll bars and/or other available options for pointing devices such as a mouse. They demand a more intuitive alternative to display and access information.

Because of this, web page designers are resorting to images to illustrate available options for users to choose. For example, a company that produces a line of, for example, home accessories, could include an image illustrating each accessory rather than providing the user a product menu or linking to a product number.

On the other hand, the well-known hyperlinks refer to an object, word or textual phrase, including an associated address base. When activating the link—using the pointing device—users are directed to the remote source, showing them the information retrieved from said source. Of course, all internet users are familiar with hyperlinks and their use.

Currently we observe a greater need to introduce improvements in the user-web page interface as a result of advances in display technologies, namely in mobile telephony and/or touchscreen devices. In this context, patent application US 2007/0124507 describes an invention providing a multimode entry that improves interfacing and allows the user to interact with other elements. This invention described in patent application US 2007/0124507 includes an entry method that shows users one or more display objects, and allows to associate at least one voice mode, one style mode, and at least one navigation voice command with those display objects. The system can provide users multiple entry possibilities, receive a voice or touchscreen command for one of multiple entries, activate voice mode and associated touchscreen mode with a specific entry, and process voice entries according to the associated voice or touchscreen mode. As a result, patent application US 2007/0124507 describes a methodology to adapt a web page for improved interaction with users.

One way to improve user-web page interface is using bitmap images. A bitmap image provides a mechanism that allows users to select one of different regions of an image. This allows pointing such regions to links or hyperlinks with information retrieved from a remote source.

Patent application US 2006/0190812 describes IT pointing systems that include procedures to produce hyperlinks for bitmap images associated with stored data. An object activated by a pointing system is implicitly identified by location and relative position to the pointing system. A geometric definition comprising the space substantially occupied by the pointed object is adequately rotated so that the perspective matches the image station. When an image is captured, image data (pixel data) is recorded and associated with bitmap objects that may point to network addresses such as URL locations (“Uniform Resource Locators”). In response, these images automatically display users network links that allow to select image fields and make possible that a navigation application points to a network recourse. As a result, in patent application US 2006/0190812 use of hyperlinks pointing to specific sectors of an image is proposed, making bitmap images a functional object capable to direct users to different external network recourses.

Additionally, patent U.S. Pat. No. 6,580,82 provides for a bitmap image component that includes: a means for onscreen image reading and display; a means to read image mapping with multiple pre-sequence color regions; a means that responds to user interaction with onscreen images and allows to obtain coordinates and a means to read color indexes in bitmap images; means sensitive to such color indexes from default color sequences that point to user selections in a region of the onscreen image.

Finally, the web page concept was designed to provide users a visual interface for the available content in different network servers. This visual interface is accompanied by a control interface through which the user accesses contents in the displayed web pages. Control interface is mainly oriented to pointing devices such as a mouse. Nevertheless, pointing devices are currently less used and have given way to interfaces that allow users to directly interact with web pages, such as touchscreen based web pages.

Afore-mentioned patent documents solve problems related to increased internet use. Interaction capabilities offered by web pages and images under the conventional web page standard provide solutions that incorporate hyperlinks to available images and improve image mapping, which makes possible to enhance user interface with objects and/or information. Nevertheless, proposed solutions do not facilitate use of complete web pages through a representation that enhances display and interaction in portable or touchscreen devices. In other words, proposed state of the art solutions are mainly oriented to the use of pointing devices that allow interaction between users and web pages and do not develop methodologies providing web page elements and a visualization facilitating user-web page interaction through different devices, touchscreen devices in particular.

Additionally, one of the issues that should be tackled by new web page display and access technologies is “scale”. In the beginning, every page had a direct relation between URL address and its content. In other words, as bandwidth limitations existed, each URL had specific content with capacity restrictions. Therefore, a URL was at large, representative of only one content type, within the web page.

Today, given advances in processing capabilities and bandwidth, the majority of web pages is content-rich, both for the kind of objects they use (images, video, and other multimedia content) and for their nature. So, today most URL addresses have multiple content, pointing to elements of different kind and nature.

On the grounds of these features, it was originally enough to interchange links or URLs, as these represented access to specific content. Today, an URL address is an access point to a website with diverse content and, besides, this content is mostly dynamic and is continuously changing. Because of this, there is a high probability that a URL you visit today will be very different to the same URL you may find 2 weeks later.

Therefore, the “scale” for interacting with web pages through URLs is now inadequate. Today we need to interact directly with objects contained within web pages and retrieve them for different purposes. That is to say, we need to propose a new user interaction scale, in which each URL is not pointing to an object per se, but granting access to a universe of objects.

### DESCRIPTION OF THE INVENTION

As mentioned earlier, state-of-the-art solutions are not oriented to facilitate interaction between users and web pages without using pointing devices such as a mouse; i.e., they are not oriented to facilitate navigation providing enhanced display of content along with an interaction associated with that display. This is a very relevant factor in the context of the user-web page interface when the device used is portable, touchscreen or of another that does not use pointing peripherals.

The present invention aims to solve the afore-mentioned problem, for which it provides web page display through a representative model that maintains all essential elements of one original web page (hyperlinks, objects, images, among others) and its functionality.

In particular, the present invention proposes a methodology for web page reading that allows obtaining all its information, including object locations, to use it in the construction of a web page representative model, which, thanks to an object location methodology, could offer the same capabilities of a conventional web page. Additionally, a system is presented to implement the proposed methodology.

When using the method and system of this invention, web page models are created that preserve object functionality, hyperlinks and, in general, all content in the original page. In this context, display of web pages based on the representative model maintains full functionality for all included hyperlinks and applications, allowing to use pointing devices such as a mouse, a pen or simply the fingers, to activate the elements and access content in the web page. Additionally, conversion of a web page into a representative and functional model allows certain operations to achieve enhanced display of content, both in portable devices and desktop computers, and also recreates a new navigation concept that meet the requirements of new devices that do not use conventional pointing methods anymore. Furthermore, this conversion brings an additional interaction dimension based on the physical layout of objects on the screen, which makes possible to interact in a “scale” lower than the one currently possible within a web page.

Thus, the conversion of web pages into representative models consists basically in recognizing the elements it contains and storing all features in storage media. Then, the data obtained from recognizing the web page is associated with its representation, storing the location for each element in the created model. Such model can be achieved by a functional reorganization of the web page, where certain elements are restructured to make managing and display easier, or by a representative image of the web page, which will preserve all features taking advantage of the bitmap image concept and the model proposed in this invention. In this context, the created model may also represent a web page in its native format, i.e., without reorganization nor generation of an image that preserves the original web page features, but may keep also additional content locations and potentially reorganization of the web page data/objects. Later, using the location procedure for web page elements, a specific location is assigned to the different web links and objects, where each location is stored to provide the capability of interacting with the user in the created representative model. So, when placing the pointer or pressing on the sectors of the model representing the objects in the web page, selected objects will be isolated and controlled thanks to their exact location being replicated in the model. As a result, the user will have full access to all objects, will be allowed to any kind of interactions in one of the invention modes, such as locally storing the object, sending or sharing it over the web, which at the same time will give the user the capability to create any kind of content display he/she may like. As a result, we obtain a full-featured web page version that facilitates interaction with the user and the display of contents in all devices, particularly touch-screen devices.

### DESCRIPTION OF FIGURES

FIG. 1. General embodiment of the web page conversion and display system.

FIG. 2. Embodiment of the display and conversion methodology used by the system.

### DETAILED DESCRIPTION OF THE INVENTION

The present invention refers to a method and system to convert a web page into a representative and functional model to interact with the user, i.e., preserving all features and attributes a web page interaction provides. Such interaction occurs through a unit that accesses all user-requested contents or data. The method includes web page display and interaction in a model created for GUI devices such as desktop computers, portable and touch-screen devices, among others.

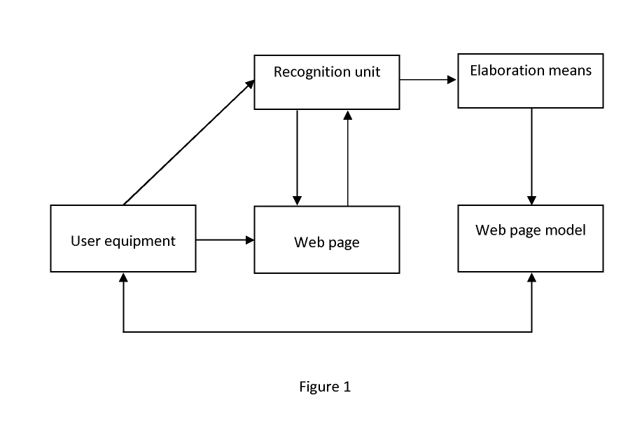

FIG. 1 shows a general embodiment of the display and conversion system, where the user accesses a web page through his/her equipment and, based on one of the invention modalities, accesses a recognition unit. Then, the recognition unit interacts with the web page to obtain the needed information to create a representative model of such page. Next, the recognition unit sends the collected data to an elaboration mean that creates the representative model of the web page. Finally, such representative model is presented to the user, who may interact with it in exactly the same way as with the original web page.

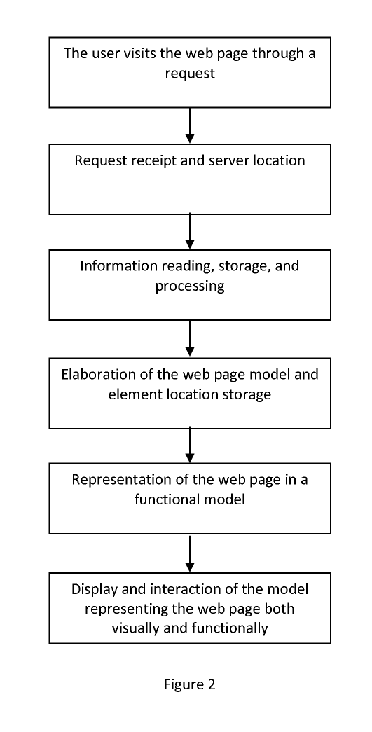

FIG. 2 shows the procedure of the methodology used by the system illustrated in FIG. 1, where the first web page conversion and display steps are identified.

The methodology and systems used by this invention are described below in greater detail.

The methodology proposed for the creation of this representative and functional model for web pages begins with the original page reading, which is performed by a recognition unit that makes possible to obtain the information requested by the user using a recognition mechanism. In an invention embodiment, this is a medium-level unit that acts on requests of the user and communicates with the servers that store the information, using scripts as recognition means that allow identifying the data the user is requesting. In other words, data transfer methods are used that interpret the information available on the web page and store the relevant data to use them later to identify the elements and objects within.

In a preferred invention embodiment, web page reading is performed through a specialized web site entering the web address or URL of the page that one needs to display, and later the information is browsed by the user. In another invention embodiment, the user equipment has software programmed with the invention methodology, which reads the requested pages and converts them in a representative model when this software is run. Another invention embodiment describes a similar software application, but incorporated into the web browser as an add-in that allows displaying visited modeled web pages automatically in the browser, maintaining attributes of the original web page and making navigation and content display easier.

Reading of information contained in a web page consists mainly in recognizing the source code used for programming. This seeks to obtain and store such code data in storage media with recognition units. This information relates directly with specific content in the web page associated with a particular location, which will be used later to associate such content to a specific location in the modeled representation. In a preferred invention embodiment, the relevant information collected while reading the web page corresponds to the DOM (Document Object Model), which provides the objects contained in the web page. DOM is an application programming interface, better known as API, that provides a standard object set to represent HTML (HyperText Markup Language) and XML (eXtensible Markup Language) documents, a standard model of how can these objects be combined and a standard interface to access them for manipulation. As a result, through this DOM we can access content, structure and styles of HTML and XML documents. In one invention embodiment, storage media are databases that hold the content requested by the user along with the location that the system assigns to such content in the representative model.

Reading of the web page is carried out by an information recognition mean that allows obtaining data requested by the user plus relevant information to generate a model representing the content requested by the user. In a preferred invention embodiment, such recognition means are scripts that use HTML5 interfaces and “client-side” languages, such as “JavaScript”, and other kinds of languages such as ECMAScript (standard programming language published by ECMA International), which make the proposed methodology possible. In this context, recognition means of the recognition unit access the information requested by the user and read the web page, collecting data from the source code and, through processing, generating new information with all needed components to create a representative model of the original web page, or of the image or canvas representing the content. This results in two stages:
1. Recognition means operating through the DOM. In an invention embodiment recognition means operate through the DOM of the web page where they are hosted. These recognition means collect the information of all elements of the page, and the data are used to create a representation. For this purpose, all elements in the recognition means should follow a “same origin policy”, that is, should belong to the same site where these recognition means are executed. If this condition is met, the recognition means will be able to read the elements without the help of a proxy server. Therefore, when using recognition means based on a language that may be run at the client side, there is no need to use a proxy server.
2. Recognition means based on a communication language, such as JavaScript for example, are used to establish the location of elements and objects through coordinates associated with CSS (“Cascading Style Sheets”) and direct hits. This method returns a visible element in a certain point, which is determined relative to the point visible in the top left position of the document. If the element in the specified position belongs to another document, for example a document of a different iframe, the element present in the document DOM that calls the function will be returned. In this example such DOM element is in the same iframe. If the specified element is anonymous, or refers to XBL-generated content such as a scroll bar, the first non-anonymous parent element will be returned. If the specific point is outside the visible part of the document, or one of the coordinates is negative, the result will be “NULL”.

This model, image or canvas is created through elaboration means with all information collected from the web page, i.e., each zone of the adaptation or each pixel of an image is assigned attributes of the web page, saving the location of objects to activate them on screen. For this, each element in the web page incorporated to the model, image or canvas is associated with X and Y coordinates in the model or in the image being created. With these coordinates we can know which elements of the web page are in each sector of the model or in each pixel of the image or canvas being created. Therefore, hyperlinks, objects and images of the web page will be associated with the representation of those elements in the generated model or image, preserving the functionality of the original web page. In a preferred invention embodiment, creation media are scripts developed using HTML5 and JavaScript interfaces.

In an invention embodiment, reading and creation of a model or canvas is carried out simultaneously, that is to say, code is read from the web page and a model or canvas for that page is created, storing spatial positions assigned to every component in the web page through coordinates. In other invention embodiment, the process described above occurs separately, i.e., first the complete code is read from the web page and later a model or canvas is created for that page, storing the location data assigned to the recognized objects in the web page.

At this stage, we have a representation of the web page in a model, image or canvas document. Such representation has information that allows to recognize, though the procedure described above and through the relative position of objects, all components or objects the user may which to access. To display the representation of the web page, display and interaction means are used, which incorporate the translation of the representation into a unique model with spatial positions associated for all contents and all objects added from the web page when the model was created. In a preferred embodiment, the model corresponds to an image or canvas that has assigned to each pixel or set of pixels the data linked to objects represented by this pixel or set of pixels. At this point, the web site is transformed into a different element or model of the original, but preserve all previous features for interaction.

Through the above described methodology we obtain a web page in a different format, which may also be an image that could be treated as such by all devices compatible with display and interaction. This new concept of web page allows to completely modify conventional treatment, as web pages are mainly designed to use pointing devices as interaction means with the user.

Once the web page conversion process is completed, we got a model that visually and functionally represents the web page content combining coordinates of those elements with the position database created at the time of generation of the representative model, with each position related to the elements read in the web page.

In an invention embodiment, the conversion of the data of the web page into a representative model or an image or canvas document is executed in the user equipment. In another invention embodiment, the data conversion into models or canvases is performed in the proxy server.

In another invention embodiment, JavaScript language is used to develop a methodology that combines conversion of a web page into a representative model or into an image with coordinates based on the preferred embodiment, with further display and interaction capabilities for such model.

In yet another invention embodiment, two open code scripts are used:

1. PHProxy,
A PHP-based (“Personal Home Page”) proxy script, which corresponds to the programming language used for web pages, allows to obtain the information requested by the user of the server or servers hosting it, which return results for those requests in a web page including HTML, JS (“JavaScript”), CSS (“Cascading Style Sheets”) and images.

2. HTML2CANVAS,
A HTML2CANVAS script is a screenshot generator that runs in the user's equipment, i.e., allows obtaining an image of the content on screen in a specific moment. This script uses JavaScript to calculate all elements present in the web page, then a HTML5 CANVAS API (Application Programming Interface) to manipulate the canvas in HTML5 language to define such elements in a canvas or image. Thus, screenshots can be exported from the image or canvas. The most important application programming interface is “canvas to DataURL”, which allows to generate images formatted with data of a particular URL.

Bearing in mind the two scripts that the invention uses in one embodiment, we have that, once the user loads the new URL, such URL is sent to the proxy server, which creates an iframe (“inline frame”) element, which is basically a HTML element that allows to insert a HTML document within a main HTML document, hidden to load the URL. The proxy is used so that the target web page finds itself in the same domain in which the methodology script resides. This way, a JavaScript sequence of commands has permission communicate with the iframe content.

After this, the proxy server receives the user request and proceeds to a normal search simulation using the web browser to find the target file. After the target server sends the requested information, the proxy server removes the script tags from the HTML code, changes the src (“source”) image attribute, which corresponds to URL, with the proxy URL, so that the images are organized in the same domain as the user's system. This procedure is very important for images that are loaded into the canvas.

In this same context, a JavaScript sequence of commands based on HTML2CANVAS is added to each HTML page requested by the proxy server. The added code transfers the HTML elements to an image canvas after the HTML page loads completely, and then transfers the information contained in the canvas to the main page for display and interaction. Additionally, JavaScript language is used to add scripts that allow capturing the position of HTML elements while the HTML2CANVAS script generates the image or canvas. This position corresponds to the location of a particular element in the image or canvas, for which a system of coordinates is used to specify the exact location.

After canvas generation, captured HTML elements may be displayed to confirm that all have been incorporated into the canvas.

Thus, after the page requested by the proxy server is completely loaded in the hidden iframe, scripts will draw HTML elements on the canvas. After this, the canvas element is attached to the main screen for display, as this canvas element includes all information of the previously captured HTML elements.

After the canvas is completed, the display methodology of previously generated image canvases kicks in. In this context, to manage the canvas representing the web page and access the elements showing in that canvas, we have that, when a user employs a pointing device, a script captures the location coordinates of the pointer to compare such coordinates with the information of the HTML elements read from the original page. The purpose of this is to verify that the HTML element is associated to those coordinates, that is, to find the elements that lies under the pointer used. In this process we may find more than one element associated to those coordinates. In this case, one way to determine which element is the one to be pointed at is sorting elements by size, selecting the longest one.

This is very relevant when considering that in a preferred invention embodiment the display equipment is a touch-screen device, where the use of a pointing peripheral is replaced by touch gestures on the screen. In this context, among the main advantages of displaying web pages as images we find the design of new ways to navigate and browse the pages, which will be more natural for hand gestures and movements on a touch screen.

Embodiments of the present invention may be implemented in connection with a special purpose or general purpose computer that include both hardware and/or software components.

Embodiments may also include physical computer-readable media and/or intangible computer-readable media for carrying or having computer-executable instructions, data structures, and/or data signals stored thereon. Such physical computer-readable media and/or intangible computer-readable media can be any available media that can be accessed by a general purpose or special purpose computer. By way of example, and not limitation, such physical computer-readable media can include RAM, ROM, EEPROM, CD-ROM or other optical disk storage, magnetic disk storage or other magnetic storage devices, other semiconductor storage media, or any other physical medium which can be used to store desired data in the form of computer-executable instructions, data structures and/or data signals, and which can be accessed by a general purpose or special purpose computer. Within a general purpose or special purpose computer, intangible computer-readable media can include electromagnetic means for conveying a data signal from one part of the computer to another, such as through circuitry residing in the computer.

When information is transferred or provided over a network or another communications connection (either hardwired, wireless, or a combination of hardwired or wireless) to a computer, hardwired devices for sending and receiving computer-executable instructions, data structures, and/or data signals (e.g., wires, cables, optical fibers, electronic circuitry, chemical, and the like) should properly be viewed as physical computer-readable mediums while wireless carriers or wireless mediums for sending and/or receiving computer-executable instructions, data structures, and/or data signals (e.g., radio communications, satellite communications, infrared communications, and the like) should properly be viewed as intangible computer-readable mediums. Combinations of the above should also be included within the scope of computer-readable media.

Computer-executable instructions include, for example, instructions, data, and/or data signals which cause a general purpose computer, special purpose computer, or special purpose processing device to perform a certain function or group of functions. Although not required, aspects of the invention have been described herein in the general context of computer-executable instructions, such as program modules, being executed by computers, in network environments and/or non-network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

Embodiments may also include computer program products for use in the systems of the present invention, the computer program product having a physical computer-readable medium having computer readable program code stored thereon, the computer readable program code comprising computer executable instructions that, when executed by a processor, cause the system to perform the methods of the present invention.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

1. A method for web page conversion and display that facilitates manipulation of those web pages or a representative model thereof in devices with and without pointing peripherals, including portable and/or touch-screen device, characterized in that it comprises the following phases:
requesting information by the user through a user unit;
reading of the requested information by the user using recognition means from a server;
storing read information in storage media contained in the recognition units;
processing read information through processing units to generate new data with the needed requirements to create a model of that information;
create, using elaboration means, a model for the web page based on the process information; and
display, using display and interaction means, the data based on the elaborated model, which will provide all features and characteristics of the original.

2. The method according to claim 1, wherein the model generated by elaboration means could correspond to the original web page with additional information from processing media or to a representative model of that web page.

3. The method according to claim 2, wherein its reading stage comprises:
recognizing information read from the server;
obtaining information relevant for the user; and
obtaining information relevant for creating a model representing the information read.

4. The method according claim 2, wherein the storage phase includes selecting the information relevant to creating the model and storing it in databases in the recognition units.

5. The method according to claim 2, wherein its processing stage comprises:
selecting information relevant to creating a model; and
generating new information with the contents needed to elaborate a model representing the information.

6. The method according to claim 2, wherein its elaboration stage comprises:
identifying the elements that make up the information relevant to elaborate the model;
reading that information while creating the model with the identified elements; and
storing the location and attributes of the elements identified in the model.

7. The method according to claim 6, wherein the location of elements is stored by means of X and Y coordinates related to the space that such element occupied at the time the information model was created.

8. The method according to claim 2, wherein its display stage comprises:
using the elaborated model to show information requested by the user;
granting access to information maintaining original functionality; and
presenting the original information by means of a model representing those data both visually and functionally.

9. The method according to claim 8, wherein access to information includes the following stages:
identifying location of the pointing device controlled by the user;
comparing that location with the locations of the elements contained in the web page model, which are stored in the storage media of the recognition units;
identifying the elements the user is pointing at; and
assigning the attributes the pointed element possesses.

10. The method according to claim 9, wherein location of the pointing device is obtained from X and Y coordinates.

11. The method according to claim 2, wherein the information requested by the user corresponds to the web page content.

12. The method according to claim 11, wherein the information requested by the user corresponds to the web page DOM.

13. The method according to claim 12, wherein the user decides the way to present original information, both visually and functionally.

14. The method according to claim 2, wherein the stage where visual adaptation takes place corresponds to the creation of an image or canvas.

15. The method according to claim 10, wherein the pointing device can be a touchscreen device, in which the control interface is in the hands of the user.

16. A system for web page conversion and display that facilitates manipulation of web pages or a representative model thereof in equipment with or without pointing peripherals, such as portable and/or touch-screen devices, comprising:
one user unit by means of which information is requested by the user:
one recognition unit that intermediates the requested between the user unit and the server;
one server that possesses the information requested by the user;
recognition means to read the information requested by the user;
storage media to collect the information requested by the user;
processing media to process the information requested by the user;
elaboration means to recreate the information requested by the user in a functional model; and
display and interaction means to present the user a functional model of the contents and attributes contained in the information requested by the user.
pointing device that allows user and system to interface.

17. The system according to claim 16, wherein the model generated through elaboration means could correspond to the original web page with additional information from processing media or to a representative model of that web page.

18. The system according to claim 17, wherein the user unit is a desktop computer.

19. The system according to claim 17, wherein the user unit is a portable device.

20. The system according to claim 17, wherein the user unit is a touch-screen device.

21. The system according to claim 17, wherein the recognition unit is a server.

22. The system according to claim 17, wherein storage media correspond to databases in the recognition unit.

23. The system according to claim 17, wherein the recognition means, the processing media, the elaboration means and the display and interaction means corresponds to scripts.

24. The system according to claim 23, wherein scripts use html5 and java interfaces.

25. The system according to claim 16, wherein the information requested by the user corresponds to the web page content.

26. The system according to claim 25, wherein the information requested by the user corresponds to the web page DOM.

27. The system according to claim 26, wherein display and interaction means allow the user to determine the way to present original information, both visually and functionally.

28. The system according to claim 17, wherein functional adaptation achieved by the elaboration means corresponds to an image or canvas.

29. The system according to claim 16, wherein the pointing device can be a touchscreen device, in which the control interface is in the hands of the user.
